(19) United States
(12) Patent Application Publication
(10) Pub. No.: US 2006/0092153 A1
(43) Pub. Date: May 4, 2006

(54) Method for power management in a display

(76) Inventors: Hong Jen Chu, Taipei City (TW); Yu Pin Chou, Tongsiao Township (TW); Shiu Rong Tong, Kaohsiung City (TW)

Correspondence Address: Raymond Sun, 12420 Woodhall Way, Tustin, CA, 92782, US

(21) Appl. No.: 11/259,541

(22) Filed: Oct. 25, 2005

(30) Foreign Application Priority Data
Oct. 29, 2004 (TW) 093133066

(51) Int. Cl. G09G 5/00

(52) U.S. Cl. 345/211

(57) ABSTRACT

A method for power management used in a display device is disclosed. When the display device enters a power-saving mode, the method performs the steps of periodically enabling a video channel of the display device, detecting a video signal of the video channel and determining either to switch the display device into a normal mode or to keep it in the power-saving mode according to the detecting result. By means of this method, the display device can achieve power saving, respond to external changes, and help to solve the problem of prior art.

### BACKGROUND OF THE INVENTION

(a). Field of the Invention

This invention relates to the field of power management, and more particularly, to the power management of the display device.

(b). Description of the Prior Arts

If a display device (for examples: CRT display or LCD display) has a power management function, the power consumption of the display device can be reduced and the components of the display device can be protected. The display power management signaling (DPMS) is a common standard for the display device. In the DPMS standard, the computer will selectively provide at least one of video signals (for example: a vertical synchronization signal, VSYNC, and a horizontal synchronization signal, HSYNC) to the display device, and the display device will determine to perform the power management function when the computer don't transfer the video signal to the display device. Generally speaking, both the computer and the display device have two operation modes (i.e., a normal mode and a power-saving mode). When the computer operates in the normal mode, the computer will transfer the video signal into the display device through a plurality of video channels of a video interface, and the display device will display the video signal in the normal mode. When the computer enters the power-saving mode (for example: a user don't use this computer for a predetermined time interval), the computer will not provide the video signal to the display device and the display device will simultaneously enter the power-saving mode.

In prior technology, there are two conventional methods for power management of the display device. The first conventional method: the display device will turn off its power supply when it enters the power-saving mode. That is, the conventional display device disables (i.e. turns off) all video channels in the power-saving mode. The second conventional method: the display device will keep enabling (i.e. turning on) one of the video channels of the video interface and disabling other video channels in the power-saving mode. Generally speaking, the conventional display device will only keep enabling a blue channel when operating in the power-saving mode. The conventional display device will detect whether the video signal is input to the display device through the enabled video channel. When the video signal of the enabled video channel is detected, other disabled video channels will be enabled and the conventional display device will return to the normal mode. In the second conventional method, although the display device can respond to external changes in the power-saving mode, the enabled video channel needs to be kept enabled all the time and the power consumption of the display device can not be fully reduced.

### SUMMARY OF THE INVENTION

It is therefore one of objectives of this invention to provide a method for power management used in a display device to resolve the above-mentioned problem.

It is therefore one of objectives of this invention to provide a method for power management used in a display device to reduce the power consumption of the display device.

According to an embodiment of this invention, this invention provides a method for power management used in a display device which has an interface comprising a video channel for receiving a video signal. The method comprises: periodically enabling the video channel in a power-saving mode of the display device and detecting the video signal of the video channel; and determining either to switch the display device into a normal mode or to keep it in the power-saving mode according to the detecting result.

According to an embodiment of this invention, this invention provides a method for power management used in a display device that has an interface comprising a plurality of video channels each for receiving a video signal. The method comprises: detecting at least one of the video signals of the video channels in a normal mode; operating in a power-saving mode when the video signal is absent; disabling the video channels for a first time interval when the display device is in the power-saving mode; and enabling at least one of the video channels and detecting the video signal of the enabled video channel for a second time interval when the display device is in the power-saving mode; wherein the display device operates in the normal mode after the video signal of the enabled video channel is detected in the power-saving mode.

### BRIEF DESCRIPTION OF THE DRAWINGS

FIG. 1 illustrates a flow chart of an embodiment of the power management method in a display device according to the present invention.

### DETAILED DESCRIPTION OF THE INVENTION

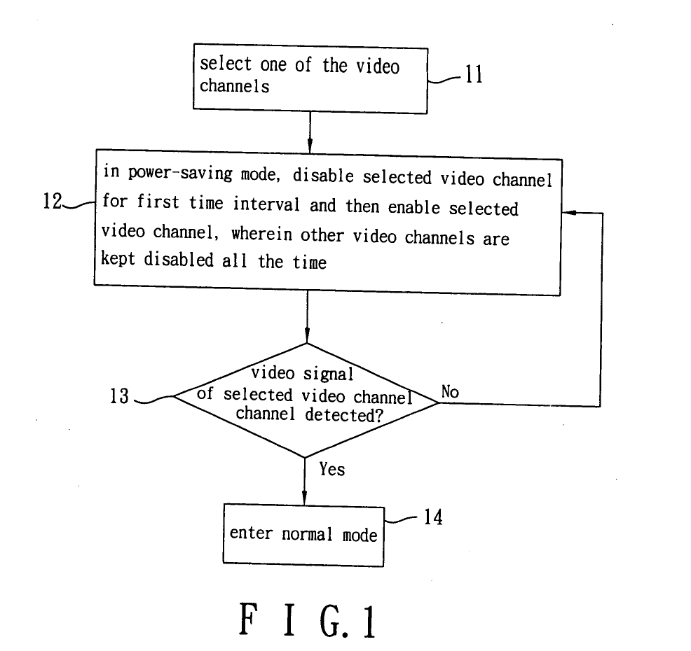

FIG. 1 illustrates a flow chart of an embodiment of the power management method in a display device according to the present invention. In the embodiment, the method of the present invention is used in the display device (for example: CRT or LCD display device). The display device includes a video interface comprising a plurality of video channels. Each video channel is used for receiving a corresponding video signal. In an embodiment, the video channels include a clock channel for receiving a corresponding clock signal. The display device can operate in a normal mode or in a power-saving mode. In the normal mode, the display device will receive the video signals through the video channels and display the video signals. In the power-saving mode, the display device of the present invention will periodically open one of the video channels to check if the video signal of the selected video channel is present such that the display device of the present invention can achieve better power saving and respond to external changes. As shown the FIG. 1, the power management method comprises the step of:
Step 11: selecting one of the plurality of video channels;
Step 12: in the power-saving mode, disabling the selected video channel for a first time interval and then enabling the selected video channel, wherein other video channels are kept disabled all the time;
Step 13: detecting the video signal of the selected video channel. If the video signal isn't detected, go to step 12; if the video signal is detected, go to step 14; and
Step 14: entering the normal mode.

In the step 12, the length of the first time interval is variable or programmable. In an embodiment, the length of the first time interval is not larger than a threshold value. In another embodiment, the length of the first time interval can be dynamically adjusted according to the number of times of opening the video channel in the power-saving mode, or the time span for staying in the power-saving mode. For example: the first time interval is progressively increased following the increase of the number of times of opening the video channel or the time span for staying in the power-saving mode. In the step 13, the detection of the video signal continues for a second time interval that is also variable or programmable. In a preferred embodiment, the second time interval is shorter than the first time interval. If the video signal is absent (i.e. not detected) during the second time interval, then the flow goes back to the step 12 to disable the selected video channel for the first time interval before re-enabling, and the power-saving mode remains. If the video signal is present (detected) during the second time interval, the flow proceeds to the step 14 to switch the display device into the normal mode. That is, the display device opens all the video channels to display the video signals. In an embodiment, when the display device doesn't receive at least one of the video signals in the normal mode, the display device will enter the power-saving mode.

In an embodiment, the video interface of the display device is a digital visual interface (DVI). The DVI utilizes Transition Minimized Differential Signaling (TMDS) standard to transmit the video signals. The DVI comprises three digital video channels and one clock channel. The three digital video channels are used to receive red digital video signal, green digital video signal, and blue digital video signal, respectively. The clock channel is used to receive a clock signal. In the step 11, one of the three digital video channels is selected. Generally speaking, the selected digital video channel is the blue channel. In the step 12, the clock channel is enabled together with the selected video channel. In the step 13, the video signal to be detected comprises a data enable (DE) signal, a horizontal synchronization (HSYNC) signal and a vertical synchronization (HSYNC) signal. The clock signal of the clock channel is also to be detected. If any one of the DE signal, the HSYNC signal and the HSYNC signal or the clock signal is absent, the step 12 is repeated to save the power consumption. If all of the DE signal, the HSYNC signal, the HSYNC signal and the clock signal are present, the display device enables all the video channels and enters the normal mode.

In another embodiment, the video interface of the display device is a VGA interface comprising red (R), green (G), and blue (B) analog video channels and two synchronization channels for receiving a horizontal synchronization (HSYNC) signal and a vertical synchronization (HSYNC) signal, respectively. If the selected video channel is the HSYNC channel (step 11), the detected signal is the HSYNC signal (step 13). If the selected video channel is the VSYNC channel (step 11), the detected signal is the VSYNC signal (step 13).

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A method for power management used in a display device which has an interface comprising a plurality of video channels for receiving a video signal, the method comprising:
disabling all the video channels in a power-saving mode of the display device;
periodically enabling one of the video channels and detecting the video signal of the enabled video channel in the power-saving mode; and determining whether the display device enters into a normal mode according to the detecting result.

2. The method of claim 1, further comprising:
repeating the periodically enabling step and the detecting step until the video signal of the enabled video channel is detected.

3. The method of claim 2, further comprising:
enabling all the video channels if the video signal of the enabled video channel is detected.

4. The method of claim 3, wherein the interface is a digital visual interface (DVI).

5. The method of claim 3, wherein the interface is a VGA interface.

6. The method of claim 3, wherein the video signal comprises a data enable signal.

7. The method of claim 2, wherein the interface is a digital visual interface (DVI).

8. The method of claim 2, wherein the interface is a VGA interface.

9. The method of claim 1, further comprising:
enabling all video channels if the video signal of the enabled video channel is detected.

10. The method of claim 1, wherein the enabled video channel is the clock channel and the video signal is the clock signal.

11. The method of claim 10, wherein the step of enabling the video channel further comprising:
enabling the clock channel; and
disabling the clock channel for a predetermined period when the clock signal is absent.

12. A method for power management used in a display device which has an interface comprising a plurality of video channels each for receiving a video signal, the method comprising:
detecting at least one of the video signals of the video channels in a normal mode;
entering in a power-saving mode when the video signal is absent;
disabling the video channels for a first time interval when the display device is in the power-saving mode; and
enabling at least one of the video channels and detecting the video signal of the enabled video channel for a second time interval when the display device is in the power-saving mode;
wherein the display device enters in the normal mode when the video signal of -the enabled video channel is detected in the power-saving mode.

13. The method of claim 12, wherein the first time interval is variable.

14. The method of claim 13, wherein the first time interval is larger than the second time interval.

15. The method of claim 13, further comprising:
adjusting the first time interval according to the number of times of enabling the video channel in the power-saving mode.

16. The method of claim 11, further comprising:
progressively increasing the first time interval in the power-saving mode.

17. The method of claim 12, wherein the first time interval is not larger than a threshold value.

18. The method of claim 12, wherein the first time interval is larger than the second time interval.
